(19) United States
(12) Patent Application Publication
(10) Pub. No.: US 2024/0323153 A1
(43) Pub. Date: Sep. 26, 2024

(54) METHOD FOR HIGH-SECURITY NETWORK MESSAGE TRANSMISSION

(71) Applicant: WALTON ADVANCED ENGINEERING INC., Kaohsiung (TW)

(72) Inventors: HONG CHI YU, Kaohsiung (TW); MAO TING CHANG, Kaohsiung (TW)

(21) Appl. No.: 18/368,065

(22) Filed: Sep. 14, 2023

(30) Foreign Application Priority Data
Mar. 20, 2023 (TW) 112110169

(51) Int. Cl. H04L 51/06; H04L 9/40

(52) U.S. Cl. CPC H04L 51/06; H04L 63/0272

(57) ABSTRACT

The present invention relates to a method for high-security network message transmission based on a virtual private network. First, an authenticated first user machine joins a virtual private network and a proprietary name is assigned to a certificate in a backend name decoder of the virtual private network; secondly, a private message sent by the first user machine through a private transfer protocol server waits in the server for reception of a second user machine with the corresponding proprietary name or is forwarded to an outside network. The technical measure which effectuates high-security network message transmission is applicable to various situations for secure communications.

### BACKGROUND OF THE INVENTION

### Field of the Invention

The present invention relates to the technology of network message transmission, particularly a method for high-security network message transmission based on a virtual private network. The method comprises a step that an authenticated user machine joins a self-configuration peer-to-peer virtual private network electrically connected with a private communication box according to a certificate and further comprises other steps: a proprietary name is assigned after a user was registered in a name decoder; the proprietary name is used in private message transmission through a private transfer protocol server for higher security of message transmission. Additionally, an encrypted gateway is also introduced in the present disclosure for stealthy and safe message exchanges and a trust relationship is created for direct stealthy encrypted message exchanges and better security of network message transmission.

### DESCRIPTION OF THE PRIOR ART

Security of message transmission is a critical issue in the current network environment. For higher security, messages are encrypted by an existing technology in general but security risks still exist in these encryption methods.

Furthermore, message security and privacy under an existing technology are plagued and threatened by cyber attacks and sniffing, which take a toll on security and privacy such as illegal disclosure of information and other consequential damages. For settlement of these problems, an existing technique usually relies on traditional encryption and firewall technologies to protect a network and messages.

However, these technologies are criticized for some drawbacks, for example, a firewall is bypassed easily and messages to be transmitted are not protected by an encryption technology. Moreover, a convenient user-friendly method for security and privacy of messages is not available to an existing technology.

The documents for patents correlated with network massage transmission are introduced as follows:

As shown in European Patent No. EP2860984A1, a method for processing messages intended to allow the access to conditional access content comprises following steps: receive various messages classified as at least two different categories by means of a security module with at least one decryption module; assign a different priority level to a message classified as a distinct category wherein one priority level is specified as the high priority and another priority level is specified as the standard priority level lower than the high priority; correlate a value with the message to which the standard priority level has been assigned; assign at least one threshold value to the value associated with the message specified as the standard priority level; and compare the threshold value assigned to a message and the value associated with the message. If no value associated with the message specified as the standard priority level exceeds the corresponding threshold value, the message will be processed according to its priority level. A message to which the high priority level has been assigned will be processed earlier than a message to which a lower priority level has been assigned. In the method disclosed in EP2860984A1, the value associated with the message specified as the standard priority level will be changed according to the predefined rule. If the value associated with one of the messages having a standard priority level exceeds the threshold value for the corresponding message, the message specified as the standard priority level will be processed earlier than the message specified as the high priority level. Similarly, the value associated with the message specified as the standard priority level will be changed according to the predefined rule.

As disclosed in Taiwan Patent No. 1751433, a secure communication key negotiation method suitable for a first mobile device includes following steps: generate a first random value; generate a first reference value based on the first random value and a given base point parameter of an elliptic curve; obtain a first system time and create a first signature after completion of signing the first reference value and the first system time by means of a first private key; transmit the first signature, the first reference value, the first system time and a first certificate to a second mobile device; receive a second signature, a second reference value, a second system time and a second certificate from the second mobile device and accordingly authenticate the second mobile device; generate a reference key and accordingly obtain a session key after authentication of the second mobile device completed; and establish a secret peer-to-peer communication session with the second mobile device based on the session key.

As disclosed in Taiwan Patent No. 1729069, a communication method and apparatus is introduced for better communication security and guaranteed benefits of participants in a communication session. The method comprises following steps: a local-end device initiates a user identity verification request to an opposite-end device; the local-end device determines that an opposite-end communication party is authenticated according to received response information wherein the response information is directly sent to the local-end device by the opposite-end device or produced by a server according to returned information from the opposite-end device; a communication process between the local-end communication party and the opposite-end communication party is completed by the local-end device when the opposite-end communication party was authenticated.

In summary, a method, as disclosed in European Patent No. EP2860984A1 for message processing based on designated priority levels/threshold values, is a technical solution for better communication security according to a predefined rule for changes of associated values; a secure communication key negotiation method suitable for a mobile device, as disclosed in Taiwan Patent No. 1751433, features some steps with respect to generation of a random value, signatures and authentication for creating a session key and effectuating a secret peer-to-peer communication session; a communication method and apparatus, as disclosed in Taiwan Patent No. 1729069, introduces steps for a user identity verification request and response information to guarantee communication security and benefits. However, how to improve privacy in a communication session is still a critical issue to be further studied.

### SUMMARY OF THE INVENTION

In virtue of the above problems, a method for high-security network message transmission in the present disclosure is performed by means of a private communication box and a virtual private network for transmission of network packets in a high-security solution.

Accordingly, a method for high-security network message transmission in the present disclosure is aimed at transmitting proprietary network packets on a virtual private network through a backend name decoder inside the virtual private network and satisfying various clients' requirements for communications by coordination of different communication protocols for e-mail and interactive-session message services.

A method for high-security network message transmission in the present disclosure is aimed at supporting end-to-end/peer-to-peer encryption on a virtual private network without message intercepted or tapped during transmission for protective privacy and data security of clients.

A method for high-security network message transmission in the present disclosure is aimed at transmitting a client's private messages from a private transfer protocol server and waiting for connections of other clients for improvement of communication efficiency and convenience due to services of the private transfer protocol server available.

A method for high-security network message transmission in the present disclosure is aimed at guaranteeing message transmission after creation of mutual trust between both participants of a communication session by means of a trust relationship invitation.

To this end, a method for high-security network message transmission is embodied according to the following technical solution. A method for high-security network message transmission based on a virtual private network comprises following steps. Step 1: a first user machine which is authenticated by means of a first certificate joins a first self-configuration peer-to-peer virtual private network electrically connected with a first private communication box; step 2: the first user machine is registered in a backend name decoder of the first self-configuration peer-to-peer virtual private network through the first certificate such that a first proprietary name is assigned to the first certificate in the backend name decoder; step 3: a first private message issued by the first user machine through a private transfer protocol server and based on a second proprietary name waits for an electrical connection with a second user machine having the second proprietary name in the private transfer protocol server or the first private message based on a common name is forwarded to an outside network.

The purposes and technical issues in the present disclosure are further embodied by referring to the following technical measures.

In the above method, information is exchanged between the backend name decoder and the private transfer protocol server.

In the above method, the private transfer protocol server coordinates e-mail service or interactive-session message service.

In the above method, the second user machine which is authenticated by means of a second certificate joins the first self-configuration peer-to-peer virtual private network electrically connected with a second private communication box.

In the above method, the second user machine is registered in a backend name decoder of the first self-configuration peer-to-peer virtual private network through the second certificate such that a second proprietary name is assigned to the second certificate in the backend name decoder.

In the above method, the second user machine electrically connected with the private transfer protocol server receives the first private message.

In the above method, the first user machine sending a trust relationship invitation through the private transfer protocol server and the second user machine receiving and approving the trust relationship invitation transmit messages from each other before step 3.

Compared with traditional technologies, a method for high-security network message transmission in the present disclosure proves effective in: (1) transmitting proprietary network packets on a virtual private network through a backend name decoder inside the virtual private network and satisfying various clients' requirements for communications by coordination of different communication protocols for e-mail and interactive-session message services; (2) supporting end-to-end/peer-to-peer encryption on a virtual private network without message intercepted or tapped during transmission for protective privacy and security of clients; (3) transmitting a client's private messages from a private transfer protocol server and waiting for connections of other clients for improvement of communication efficiency and convenience due to services of the private transfer protocol server available; (4) guaranteeing message transmission after creation of mutual trust between both participants of a communication session by means of a trust relationship invitation.

### BRIEF DESCRIPTIONS OF THE DRAWINGS

FIG. 1 is the flowchart about a method for high-security network message transmission in the first embodiment.

FIG. 2 is the first flowchart about a method for high-security network message transmission in the first embodiment.

FIG. 3 is the second flowchart about a method for high-security network message transmission in the first embodiment.

FIG. 4a is the schematic view of step 1 in a method for high-security network message transmission in a preferred embodiment.

FIG. 4b is the schematic view of step 2 in a method for high-security network message transmission in a preferred embodiment.

FIG. 4c is the first schematic view of step 3 in a method for high-security network message transmission in a preferred embodiment.

FIG. 4d is the second schematic view of step 3 in a method for high-security network message transmission in a preferred embodiment.

FIG. 5a is the schematic view of step 1a in a method for high-security network message transmission in a preferred embodiment.

FIG. 5b is the schematic view of step 2a in a method for high-security network message transmission in a preferred embodiment.

FIG. 5c is the first schematic view of step 3a in a method for high-security network message transmission in a preferred embodiment.

FIG. 6a is the first schematic view of step 2b in a method for high-security network message transmission in a preferred embodiment.

FIG. 6b is the second schematic view of step 2b in a method for high-security network message transmission in a preferred embodiment.

### DETAILED DESCRIPTIONS OF THE PREFERRED EMBODIMENTS

A method for high-security network message transmission is explained in the preferred embodiments for clear understanding of purposes, characteristics and effects of the present application.

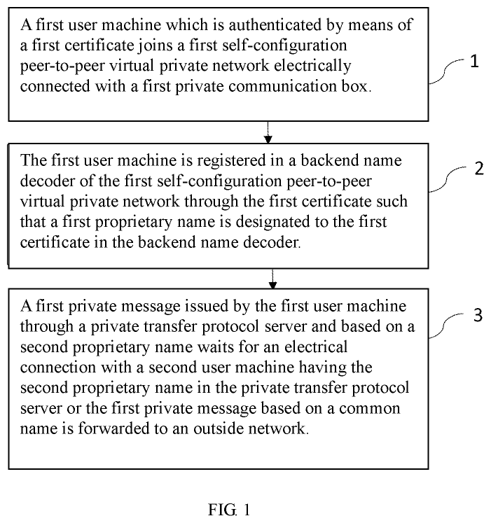

As shown in FIG. 1, a method for high-security network message transmission is presented in the first embodiment. Referring to the flowchart in FIG. 1, which illustrates a method for high-security network message transmission comprises step 1 (1), step 2 (2) and step 3 (3).

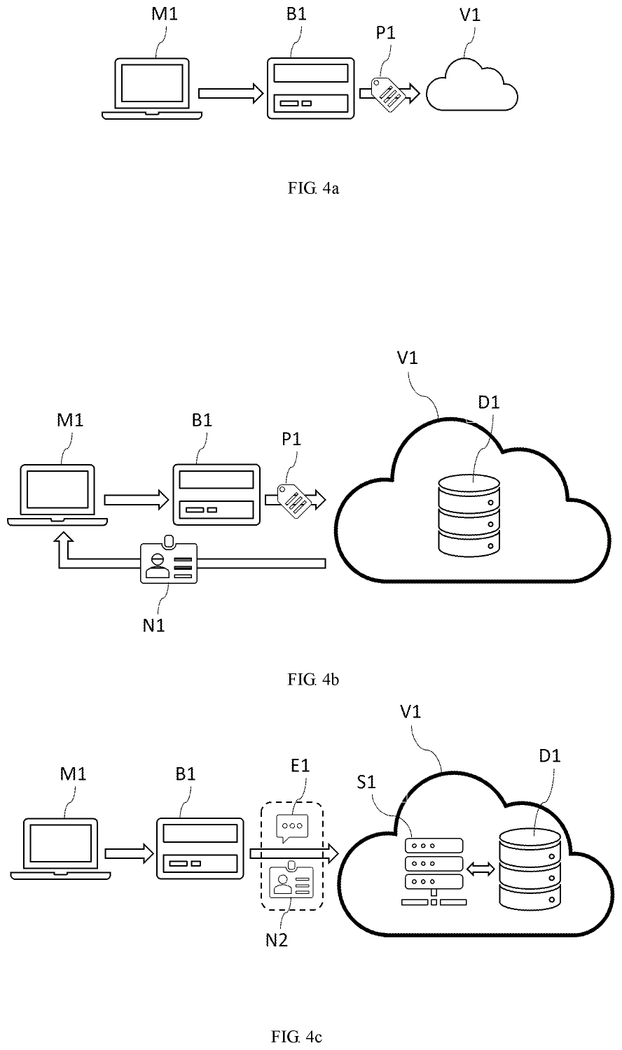

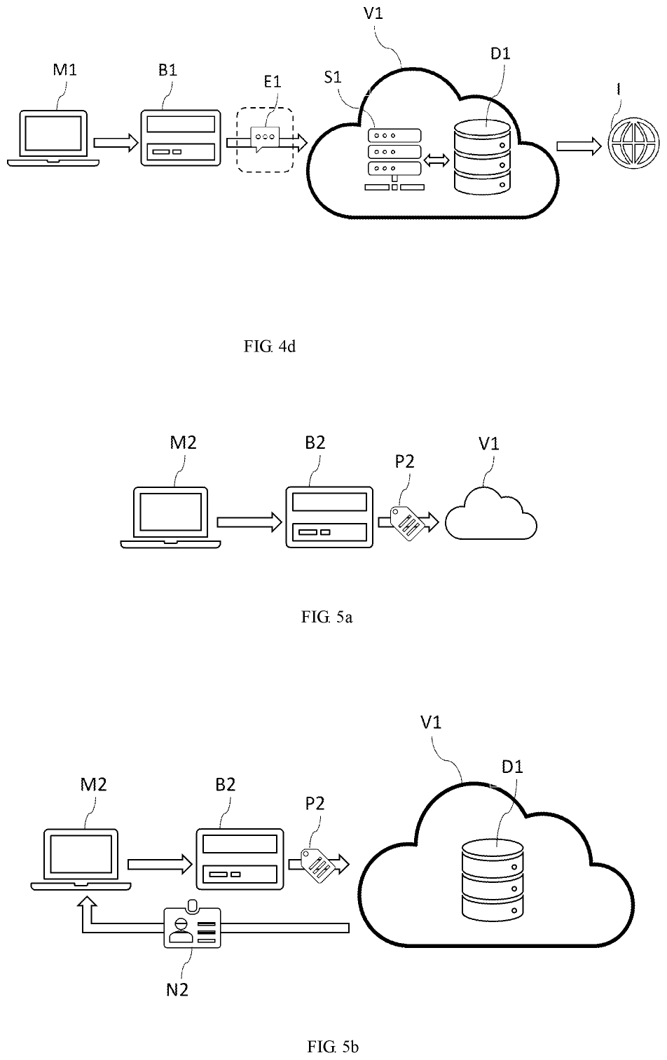

As shown in FIGS. 1 and 4a, a first user machine (M1) which is authenticated based on a first certificate (P1) joins a first self-configuration peer-to-peer virtual private network (V1) electrically connected with a first private communication box (B1) in step 1 (1).

Specifically, step 1 (1) is aimed at higher-security message transmission effectively because a virtual peer-to-peer connection is created on the first self-configuration peer-to-peer virtual private network (V1) through a dedicated line or an existing network according to a tunneling protocol for higher security of message transmission and network management capacity. Moreover, a user relying on a method for high-security network message transmission is able to remotely access resources available on a dedicated line through the internet. In the present disclosure, the first user machine (M1), which denotes a facility for network connectivity such as a desktop computer, a laptop, a tablet computer or a mobile phone, is electrically connected with the first private communication box (B1) by means of a wireless or wired connection. Moreover, the first private communication box (B1) denotes a hardware facility for internet connectivity through which a network is accessed by means of a wireless or wired connection, digital data are read and stored by the first private communication box (B1), and encryption and/or decryption operations are performed in the first private communication box (B1). The first user machine (M1) is run by an embedded OS and characteristic of Operating System Level Virtualization with which the OS kernel is virtualized. Additionally, the first certificate (P1), which denotes a tool for user authentication such as a verification code, a username/password, an encryption key or a combination thereof, is created for a user according to a user's identification entered during a login process and used later. The first certificate (P1) functions as user authentication; the first self-configuration peer-to-peer virtual private network (N1), which denotes a virtualized private network constructed through Virtual Private Network (VPN) or Containers, is aimed at creating a virtual peer-to-peer connection by means of a tunneling protocol on a dedicated line or an existing network for remote access to resources on a dedicated line from the internet. As such, network security and management capability are strengthened.

Referring to FIGS. 1 and 4b, which illustrate the first user machine (M1) is registered in a backend name decoder (D1) of the first self-configuration peer-to-peer virtual private network (V1) through the first certificate (P1) such that a first proprietary name (N1) is assigned to the first certificate (P1) in the backend name decoder (D1) in step 2 (2).

The step 2 (2) is aimed at creation of a relationship between an identity message of the first user machine (M1) on the first self-configuration peer-to-peer virtual private network (V1) and a corresponding proprietary name after the first user machine (M1) was registered in the backend name decoder (D1) by means of the first certificate (P1). The above purpose is to guarantee safe communication available to the first user machine (M1) not pretended by any other user on the first self-configuration peer-to-peer virtual private network (V1). Specifically, the first user machine (M1) is authenticated by the backend name decoder (D1) according to the first proprietary name (N1) in the first certificate (P1) for safe communication between the first user machine (M1) and other user machines. In the present disclosure, the backend name decoder (D1) functions as a network server with which a corresponding relation between a domain name and an IP address is analyzed and translated. When a network connection request is issued, a target domain name rather than a realistic IP address is identified by a browser or another application program in general. Comparatively, the target domain name can be translated to a corresponding IP address for network services correctly available to a browser or an application program as required with the network connection request received by the backend name decoder (D1). In the embodiment, the backend name decoder (D1) is also used in information exchanges between the first private communication box (B1) and a private transfer protocol server for safe communications of user machines on the first self-configuration peer-to-peer virtual private network (V1). Moreover, the first proprietary name (N1) functions as an authentication tag of the first user machine (M1) in the backend name decoder (D1) for resources inside the virtual private network (V1) available to a user machine.

Referring to FIGS. 1a, 4c and 4d, which illustrate a first private message (E1) issued by the first user machine (M1) through a private transfer protocol server (S1) and based on a second proprietary name (N2) waits for an electrical connection with a second user machine (M2) having the second proprietary name (N2) in the private transfer protocol server (S1) or the first private message (E1) based on a common name (NO) is forwarded to an outside network (I) in step 3 (3).

The step 3 (3) is aimed at rendering a safe message transmission method through the private transfer protocol server (S1) such that a user makes use of the second proprietary name (N2) to wait for a specific target user machine and a message is received by the target user machine. Moreover, the first private message (E1) forwarded to an outside network (I) by means of a common name (N0) implies lower-level-security message transmission; the private transfer protocol server (S1) is a server in which private messages are processed. For higher-level-security message transmission, the first private message (E1) is received by the authenticated second user machine (M2) only in step 3 (3) wherein information is exchanged between the backend name decoder (D1) and the private transfer protocol server (S1) and services are available with the private transfer protocol server (S1) coordinating Simple Mail Transfer Protocol (SMTP) or interactive-session message service. The first private message (E1) denotes a private message issued by the first user machine (M1) through the private transfer protocol server (S1) and received by the second user machine (M2) with a corresponding certificate and a proprietary name for no message stolen or tampered by an unrelated third party as well as privacy and security of communications. The second proprietary name (N2) functions as an authentication tag of the second user machine (M2) in the backend name decoder (D1) for resources inside the virtual private network (V1) available to a user machine. The second user machine (M2), which denotes a facility for network connectivity such as a desktop computer, a laptop, a tablet computer or a mobile phone, is electrically connected with the second private communication box (B2) by means of a wireless or wired connection. The common name (N0) denoting a common name on the internet, for example, an ordinary email address is used in message transmission through which information is transmitted to a facility outside the first self-configuration peer-to-peer virtual private network (V1). The outside network (I) denotes a network connected to a public network outside the first self-configuration peer-to-peer virtual private network (V1). Accordingly, the first private message (E1) based on the common name (N0) will be forwarded to a public network rather than inside of the first self-configuration peer-to-peer virtual private network (V1) and privacy protection is not available to the first private message (E1).

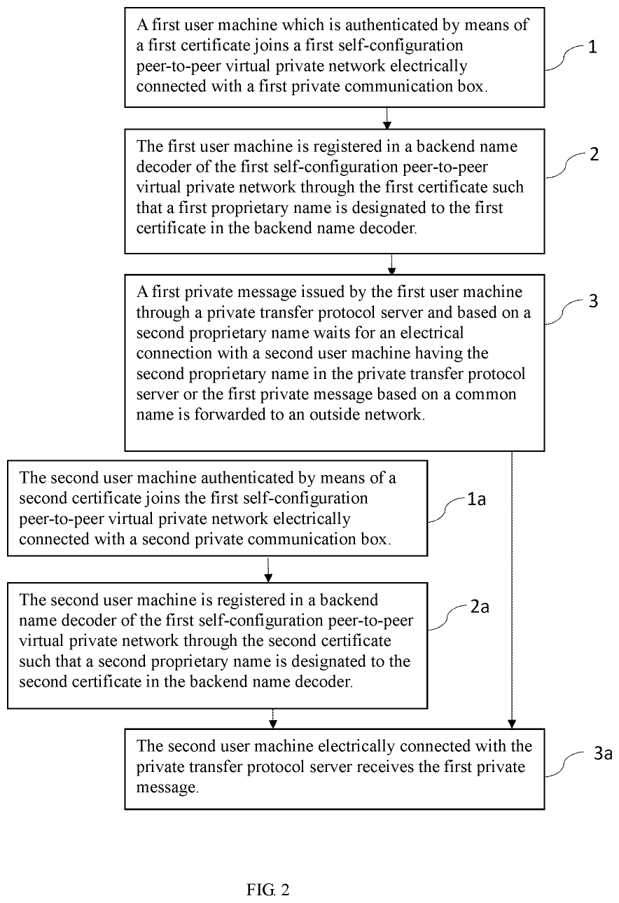

Referring to FIGS. 2, 5a, 5b and 5c, which illustrate a method for high-security network message transmission created in the second embodiment. In the second embodiment, the features identical to those of the first embodiment as shown in FIGS. 1, 4a, 4b, 4c and 4d and the same symbols marked in FIGS. 2, 5a, 5b and 5c are not explained repeatedly. Compared with the first embodiment, the method in the second embodiment comprises step 1a (la), step 2a (2a) and step 3a.

Referring to FIG. 2, which illustrates a flowchart for the second embodiment comprises step 1 (1), step 2 (2) and step 3 (3). In FIG. 2, each of step 1 (1), step 2 (2) and step 3 (3) is introduced in the first embodiment and not explained repeatedly.

Furthermore, referring to step 1a (1a) in FIG. 2 and FIG. 5a. As shown in step 1a (1a), the second user machine (M2) authenticated by means of a second certificate (P2) joins the first self-configuration peer-to-peer virtual private network (V1) electrically connected with a second private communication box (B2).

The step 1a (1a) is aimed at high-security message transmission effectively because a virtual peer-to-peer connection is created on the first self-configuration peer-to-peer virtual private network (V1) through a dedicated line or an existing network according to a tunneling protocol for higher security of message transmission and network management capacity. Moreover, a user relying on a method for high-security network message transmission is able to remotely access resources available on a dedicated line through the internet. In the present disclosure, the second user machine (M2), which denotes a facility for network connectivity such as a desktop computer, a laptop, a tablet computer or a mobile phone, is electrically connected with the second private communication box (B2) by means of a wireless or wired connection. Moreover, the second private communication box (B2) denotes a hardware facility for internet connectivity through which a network is accessed by means of a wireless or wired connection, digital data are read and stored by the second private communication box (B2), and encryption and/or decryption operations are performed in the private communication box (B2). The second user machine (M2) is run by an embedded OS and characteristic of Operating System Level Virtualization with which the OS kernel is virtualized. Additionally, the second certificate (P2), which denotes a tool for user authentication such as a verification code, a username/password, an encryption key or a combination thereof, is created for a user according to a user's identification entered during a login process and used later. The second certificate (P2) functions as user authentication; the first self-configuration peer-to-peer virtual private network (V1), which denotes a virtualized private network constructed through Virtual Private Network (VPN) or Containers, is aimed at creating a virtual peer-to-peer connection by means of a tunneling protocol on a dedicated line or an existing network for remote access to resources on a dedicated line from the internet. As such, network security and management capability are strengthened.

Referring to step 2a (2a) in FIGS. 2 and 5b. As shown in step 2a (2a), the second user machine (M2) is registered in a backend name decoder (D1) of the first self-configuration peer-to-peer virtual private network (V1) through the second certificate (P2) such that a second proprietary name (N2) is assigned to the second certificate (P2) in the backend name decoder (D1).

The step 2a (2a) is aimed at creation of a relationship between an identity message in the first self-configuration peer-to-peer virtual private network (V1) and a corresponding proprietary name after the first user machine (M1) was registered in the backend name decoder (D1) through the second certificate (P2). The above purpose is to guarantee safe communication available to the second user machine (M2) not pretended by any other user on the first self-configuration peer-to-peer virtual private network (V1). Specifically, the second user machine (M2) is authenticated by the backend name decoder (D1) according to the second proprietary name (N2) in the second certificate (P2) for safe communication between the second user machine (M2) and other user machines. In the present disclosure, the backend name decoder (D1) functions as a network server with which a corresponding relation between a domain name and an IP address is analyzed and translated. When a network connection request is issued, a target domain name rather than a realistic IP address is identified by a browser or another application program in general. Comparatively, the target domain name can be translated to a corresponding IP address for network services correctly available to a browser or an application program as required with the network connection request received by the backend name decoder (D1). In the embodiment, the backend name decoder (D1) is also used in information exchanges between the second private communication box (B2) and a private transfer protocol server for safe communications of user machines on the first self-configuration peer-to-peer virtual private network (V1). Moreover, the second proprietary name (N2) functions as an authentication tag of the second user machine (M2) in the backend name decoder (D1) for resources inside the virtual private network (V1) available to a user machine.

Furthermore, referring to step 3a (3a) in FIG. 2 and FIG. 5c. As shown in step 3a (3a), the second user machine (M2) electrically connected with the private transfer protocol server (S1) receives the first private message (E1).

The step 3a (3a) is aimed at the second user machine (M2) electrically connected with the private transfer protocol server (S1) as well as receiving the first private message (E1). Because of application of the second proprietary name (N2), the second user machine (M2) with the corresponding second proprietary name (N2) is identified by the private transfer protocol server (S1) and receives a message from the private transfer protocol server (S1). As such, the message will be transmitted to a target user rather than the other third party intending to check or tamper the message.

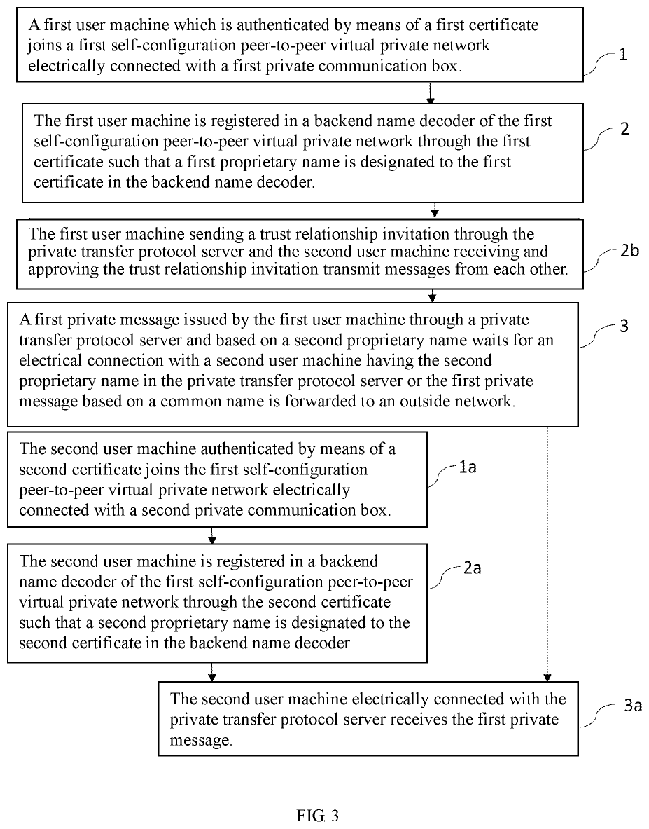

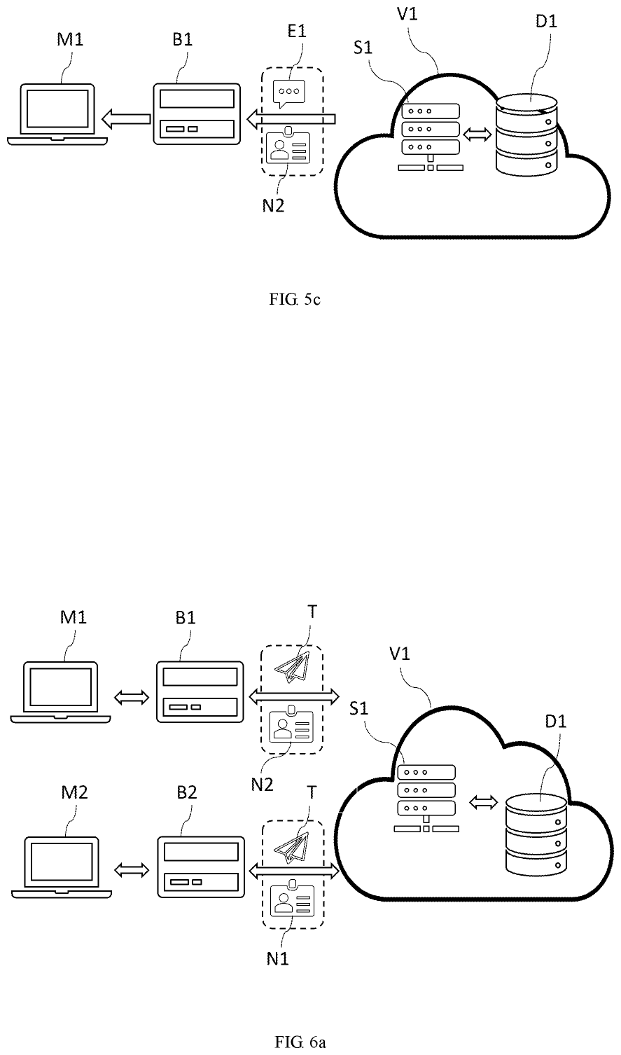

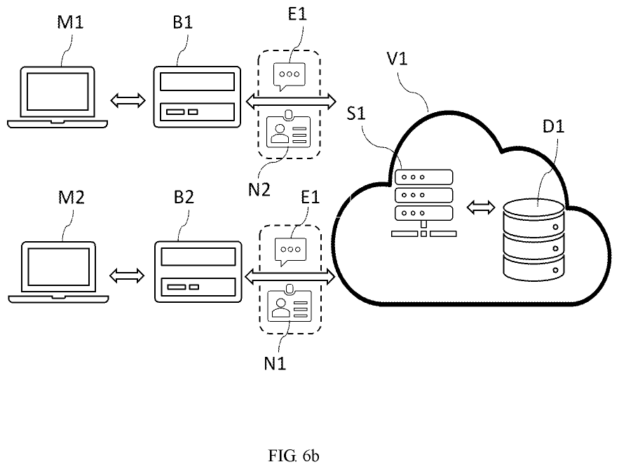

Preferably, as shown in FIGS. 3, 6a and 6b, step 2b (2b) is added before step 3 (3): the first user machine (M1) sending a trust relationship invitation (T) through the private transfer protocol server (S1) and the second user machine (M2) receiving and approving the trust relationship invitation (T) transmit messages from each other.

In the present disclosure, the introduction of the trust relationship invitation (T) is aimed at creation of a trust relationship between two users such that a message is delivered to and received by a user approved for improvement of overall system security. When a trust relationship invitation is delivered to the second user machine (M2) from the first user machine (M1), the second user machine (M2) might opt to or not to approve the invitation. Messages will be transferred between both users if the invitation is approved by the second user machine (M2). As such, any private communication is not accessed by an unauthorized third party but received by a user approved only.

In summary, a method for high-security network message transmission in the present disclosure is different from an ordinary solution for improvement of network security and refers to as creative work in applications of network message transmission that meets patentability and is applied for the patent.

It should be reiterated that the above descriptions present the preferred embodiments of a method for high-security network message transmission and any equivalent changes or modifications in specifications, claims or drawings still belong to the technical field within the present disclosure with reference to claims hereinafter.

What is claimed is:

1. A method for high-security network message transmission based on based on a virtual private network and comprising steps as follows:
step 1: a first user machine which is authenticated by means of a first certificate joins a first self-configuration peer-to-peer virtual private network electrically connected with a first private communication box;
step 2: the first user machine is registered in a backend name decoder of the first self-configuration peer-to-peer virtual private network through the first certificate such that a first proprietary name is assigned to the first certificate in the backend name decoder;
step 3: a first private message issued by the first user machine through a private transfer protocol server and based on a second proprietary name waits for an electrical connection with a second user machine having the second proprietary name in the private transfer protocol server or the first private message based on a common name is forwarded to an outside network.

2. The method as claimed in claim 1 wherein information is exchanged by the backend name decoder and the private transfer protocol server.

3. The method as claimed in claim 1 wherein the private transfer protocol server coordinates e-mail service or interactive-session message service.

4. The method as claimed in claim 1 wherein the second user machine which is authenticated by means of a second certificate joins the first self-configuration peer-to-peer virtual private network electrically connected with a second private communication box.

5. The method as claimed in claim 4 wherein the second user machine is registered in a backend name decoder of the first self-configuration peer-to-peer virtual private network through the second certificate such that a second proprietary name is assigned to the second certificate in the backend name decoder.

6. The method as claimed in claim 5 wherein the second user machine electrically connected with the private transfer protocol server receives the first private message.

7. The method as claimed in claim 6 wherein the first user machine sending a trust relationship invitation through the private transfer protocol server and the second user machine receiving and approving the trust relationship invitation transmit messages from each other before step
